(19) United States
(12) Patent Application Publication
(10) Pub. No.: US 2014/0216201 A1
(43) Pub. Date: Aug. 7, 2014

(54) CAMSHAFT, ESPECIALLY FOR MOTOR VEHICLE ENGINES

(71) Applicants: Michael Kunz, Muelsen (DE); Bernd Mann, Zschopau (DE); Markus Melzer, Burkhardtsdorf (DE); Juergen Meusel, Dittmannsdorf (DE)

(72) Inventors: Michael Kunz, Muelsen (DE); Bernd Mann, Zschopau (DE); Markus Melzer, Burkhardtsdorf (DE); Juergen Meusel, Dittmannsdorf (DE)

(21) Appl. No.: 14/236,420

(22) PCT Filed: Aug. 1, 2012
(86) PCT No.: PCT/EP2012/065036

§ 371 Date: Apr. 8, 2014

(30) Foreign Application Priority Data
Aug. 18, 2011 (DE) 102011052822.9

(51) Int. Cl. F16H 25/08

(52) U.S. Cl. CPC F16H 25/08
USPC 74/567

(57) ABSTRACT

The invention relates to a camshaft, especially for motor vehicle engines, comprising a first shaft and a second shaft forming a hollow outer shaft (1) and an inner shaft (2) arranged coaxially in the outer shaft (1) and mounted in such a way that it can rotate in relation to the outer shaft (1). Said camshaft also comprises first cams (3a) arranged on the outer shaft (1) in a rotationally fixed manner, and second cams (3b) that are arranged on the outer shaft (1) and fixed to the inner shaft (2). According to the invention, the first shaft and the second shaft are supported against each other in the axial direction (x) by means of a formfitting shape (5), the first shaft, seen in the axial direction (x), comprising a first contact surface (6a) on one side of the formfitting shape (5) and a second contact surface (6b) on the other side of the formfitting shape (5), for supporting the second shaft in a rotationally movable manner by means of the formfitting shape (5).

The invention relates to a camshaft, in particular for a motor-vehicle engine, having a first shaft and a second shaft that form a hollow outer shaft and an inner shaft that is coaxially mounted in the outer shaft and can be rotated relative to the outer shaft, including first cams that are rotationally fixed on the outer shaft and second cams that are rotatable on the outer shaft and are fixed to the inner shaft. In the context of the invention, depending on the particular embodiment, the first shaft may be the outer shaft or the inner shaft, and the second shaft will then correspondingly be the inner shaft or the outer shaft.

By adjusting the first shaft relative to the second shaft allows control of the valves of an internal combustion engine. Thus, for example, the ratio between the intake timing and the exhaust timing may be modified as a function of load and rotary speed, and the intake valves on the one hand and the exhaust valves on the other hand can be actuated using the respective groups of cams that can be adjusted relative to each other. Rotation of the inner shaft and the outer shaft relative to each other is generally carried out by adjusters that can also be referred to as phasers.

In order to enable a precise positioning of the shafts and at the same time easy adjustability of the inner shaft relative to the outer shaft, the two shafts need to be supported in a suitable manner for rotation relative to each other. Thus, it is known in a generic camshaft having the features described above according to DE 39 43 426 to provide sleeve bearings on the ends of the shaft elements lying inside of each other, which apart from a radial support also effect an axial fixing. The disadvantage arises that the axial support is provided by elements that are separated and are widely spaced from each other, and for this reason there is not only an increased production complexity, but also an increased risk of malfunction. For a precise axial support it is also advantageous if dimensionally stable materials are provided on the support surfaces that preferably also have a similar thermal expansion coefficient. An axial support via soft seals or the like is, as a rule, not sufficient.

In view of the above, the object of the invention is to provide an adjustable camshaft having an inner shaft and an outer shaft, where precise and reliable support axially is realized in a simple manner.

Starting from a camshaft having the features described above, according to the invention the object is achieved in that the first shaft and the second shaft are supported relative to each other axially by an interlocking formation, the first shaft having a first contact surface on one side, viewed axially, of the interlocking formation and a second contact surface for rotational support of the second shaft on the other side of the interlocking formation through the interlocking formation. In the context of the invention, a shaft is not just understood to mean a tubular or rod-shaped base body, but also a unit formed from one or more components connected to each other in a rotationally fixed manner. Depending on the embodiment, the interlocking formation may be provided for sliding or rolling support of the roller bearing type, and in this case several interlocking formations that are separate from each other will expediently be provided.

According to some of the embodiments according to the invention, the support location for axially supporting the inner shaft and the outer shaft is provided at one of the shaft ends. The interlocking formation is then usually part of the second shaft, so that the interlocking formation as a component of the second shaft cooperates with the contact surfaces of the first shaft that bear axially oppositely on it. In the context of such a view, the association of the first shaft and the second shaft with the outer shaft and the inner shaft has not yet been established.

According to a preferred development, it is provided on the basis of this that the inner shaft extends at one camshaft end beyond a tubular base body of the outer shaft and has there the interlocking formation that projects radially beyond the inner diameter of the base body of the outer shaft.

In the context of the described embodiment, a particularly simple design is achieved if the interlocking formation, for example a circumferential annular projection, is braced axially in one direction on an end face of the tubular base body of the outer shaft, and the second contact surface is then formed by a part of the outer shaft that is connected to the base body in an axially fixed manner. Such a part may for example have a region of enlarged diameter by which it is attached to the base body from the outside and can be fastened in a suitable manner.

The use of such an approach also brings with it the advantage that this part, which in principle may also be a functional element of the camshaft, is axially pushed onto the base body during installation using a force that allows on the one hand minimal play to be achieved and on the other hand also allows sufficient rotatability without jamming.

In the context of the invention it is of advantage if the surfaces cooperating with the axial support, which means the two contact surfaces as well as the associated faces of the interlocking formation, are provided with some surface finishing. Apart from fine grinding, additionally or alternatively also hardening, coating or the like come into consideration.

According to an alternative further embodiment of the invention, the interlocking formation as a component of the inner shaft, viewed axially, is supported on either side on opposite contact surfaces of a part that is axially fixed to the base body or on contact surfaces of two parts of the outer shaft that are connected to the base body. the interlocking formation is supported on one side on a part that is also a functional element of the camshaft, whereas on the other side, a simple end ring is inserted into this functional element to achieve an axial termination.

If the interlocking formation is formed as a radial projection of the inner shaft, then this interlocking formation may be formed either on a tubular or rod-shaped inner shaft base body or on a part that is connected to the inner shaft base body. The machining of the interlocking formation on the rod-shaped inner shaft base body is for example possible by casting or forging. Moreover, the interlocking formation may also be produced by machining, for example turning. If, according to a further described alternative, the interlocking formation is formed by a separate part that is axially fixed to the inner shaft base body, the advantage is achieved that the inner shaft base body itself may be very simply implemented as a straight rod, as a tube or the like, and in this case also a particularly cost-effective and simple production of the inner shaft base body is possible.

In case the interlocking formation of the inner shaft according to the particularly simple embodiment described above is provided between the end face of the base body of the outer shaft as well as a part that is connected to the base body in an axially fixed manner, then this part may also be a sleeve.

In the variant according to the invention as described above, the support is at a shaft end. However, an alternative concept according to the invention allows the camshaft to be axially supported in any desired position. According to this alternative concept according to the invention the inner shaft and the outer shaft each have, at a support location, starting from an annular gap between the inner shaft and the outer shaft, a recess in the form of an indent, a groove or an opening, and as an interlocking formation at least one separate interlocking member that engages in these recesses.

The interlocking element may be fixed to the inner shaft or the outer shaft. Even if the outer shaft and the inner shaft are formed from several parts that are connected to each other in a fixed manner, in the context of the invention the interlocking element is, even in the case of a fixed connection thereof to one of the shafts, regarded as a separate element that as a rule is exclusively used as an axial support.

According to a first variant of this alternative concept, the outer shaft has at the support location at least one opening and the inner shaft has a groove, and at least one interlocking element is inserted into the opening and engages in the groove. In the context of such an embodiment, the interlocking element may be retrospectively inserted, and in this case the interlocking element may be fixed to the inner shaft or the outer shaft. The interlocking element can, for example, be a small flat plate of the groove stone type; however, a certain way of securing this interlocking element has to be provided. The interlocking element may here be fastened to the inner shaft or the outer shaft, and in this case the other shaft provides the contact surfaces acting in the axial direction on either side of the interlocking element.

In order to achieve a uniform support, preferably a plurality of interlocking elements is provided and distributed around the circumference.

If the outer shaft is provided with a radially throughgoing opening, then this region can also be covered with a ring. The ring may be provided as protection from mechanical damage and contamination. Further, a ring may be used to prevent large amounts of oil from escaping through the opening of the outer shaft. In particular, in the context of the invention it is possible to apply oil to the annular gap between the inner shaft and the outer shaft, in order to ensure sufficient lubrication and free movement.

If the interlocking element has the form of a small plate, a sliding block or a groove stone, longitudinal angularly extending slots are as a rule provided as openings in the outer shaft.

If a simple ball or a plurality of balls is provided as interlocking elements, a simple, round hole in the outer shaft is sufficient to allow the ball to be inserted from the outside during the mounting process. This ball will then cooperate with the edges of the hole as well as with an indent in the inner shaft. The inner shaft may in particular include an indent in the form of a running surface having the shape of an arc of a circle, so that support can then be achieved in the manner of a ball bearing. In order to keep at least one ball or the balls in a predefined position and to secure it/them against falling out, a ring restricting the ball is provided in the outer shaft in the case of a continuous opening. A further advantage of this solution is moreover that the ring and the ball may then constitute also a radial support for the inner shaft.

According to an alternative embodiment the outer shaft has, starting from the annular gap, a recess in the form of a groove. In the context of such an embodiment, the outer shaft is closed to the side, so that the at least one interlocking element has to be inserted into the groove from the inside during the mounting process. To this end, the interlocking element is mounted on the inner shaft in a radially movable manner and an elastic pressure element is applied thereto. Thus, for example an interlocking element in the form of a ball with a spring provided underneath may be inserted into a blind bore of the inner shaft. Alternatively, also two opposite balls having a spring provided between them is possible.

During the mounting process, the balls are then pushed into the opening so far that the inner shaft can be inserted into the outer shaft. Once the groove has been reached, the balls will be pushed outward by the spring, as a result of which the desired fixing axially and, in the case of a suitable design, also radially is achieved. In order to enable support radially, in an arrangement having two balls, these have to be decoupled from each other. In the case of an embodiment with a continuous spring, such a spring has to be correspondingly fixed to the inner shaft at the center thereof.

According to a further variant, the inner shaft has an opening on the support location, and the outer shaft also has an elongate hole respectively on either side of the opening that extends in the circumferential direction, and a pin inserted into the opening is provided as an interlocking element. Unlike the simple fixing of the second shafts with a pin, the pin is here provided for a precise axial support. Apart from a simple round, cylindrical pin it is also possible for the pin to have lateral planar surfaces on at least one end that are provided for axial support. In this way, instead of a punctiform or linear support, a planar support is achieved, as a result of which the wear characteristics may be improved even in the case of prolonged use of the camshaft.

In the various described embodiments, not only an axial support but in principle also a radial support may be provided, if the interlocking formation cooperates with a corresponding radial contact surface of the first shaft also radially.

The invention will be explained below with reference to drawings that show only one embodiment. Therein:

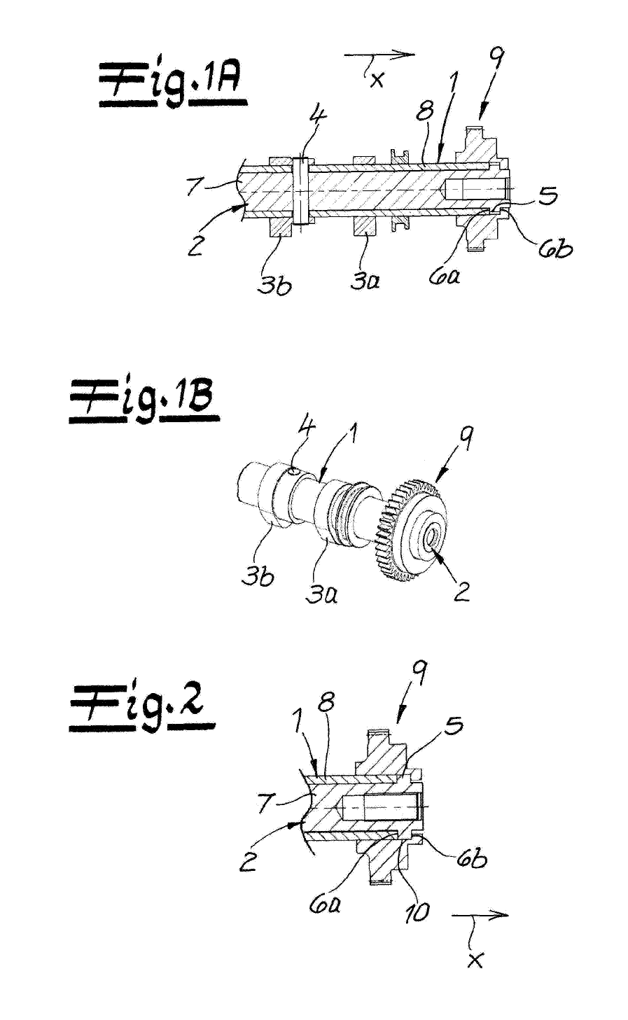

FIG. 1A is a longitudinal section through the end of an adjustable camshaft according to the invention,

FIG. 1B is a perspective view of the assembly according to FIG. 1A,

FIG. 2 is a longitudinal section through an alternative embodiment of the camshaft,

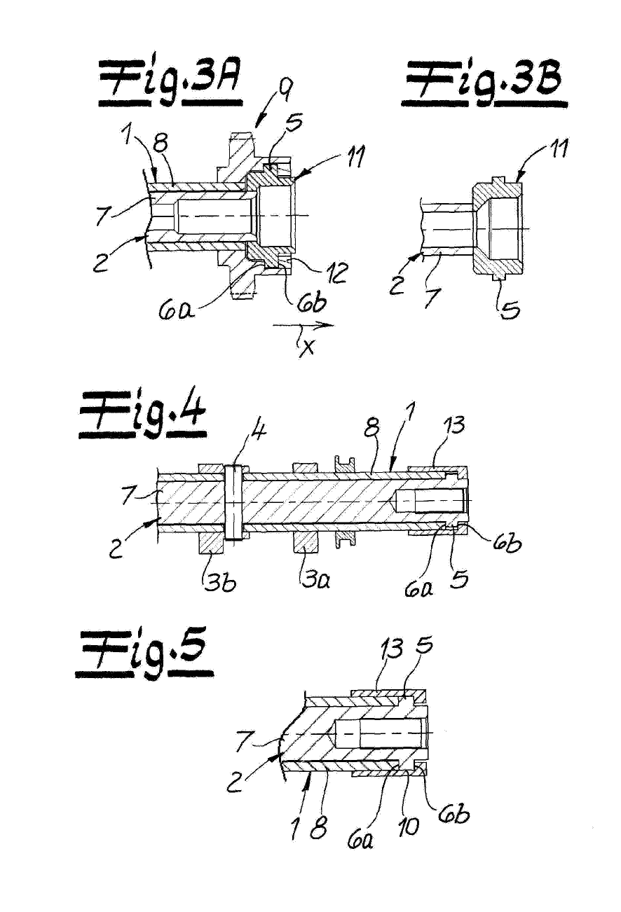

FIG. 3A is a longitudinal section through an alternative embodiment of the camshaft, where an inner shaft and an outer shaft are each formed from a base body or from an inner shaft base body as well as from parts fixed thereto,

FIG. 3B shows an alternative detailed embodiment to the one of FIG. 3A,

FIGS. 4 and 5 show alternative embodiments of the camshaft according to the invention,

FIG. 6A is a perspective view of an alternative embodiment of the camshaft according to the invention,

FIG. 6B shows only the inner shaft of the camshaft shown in FIG. 6A,

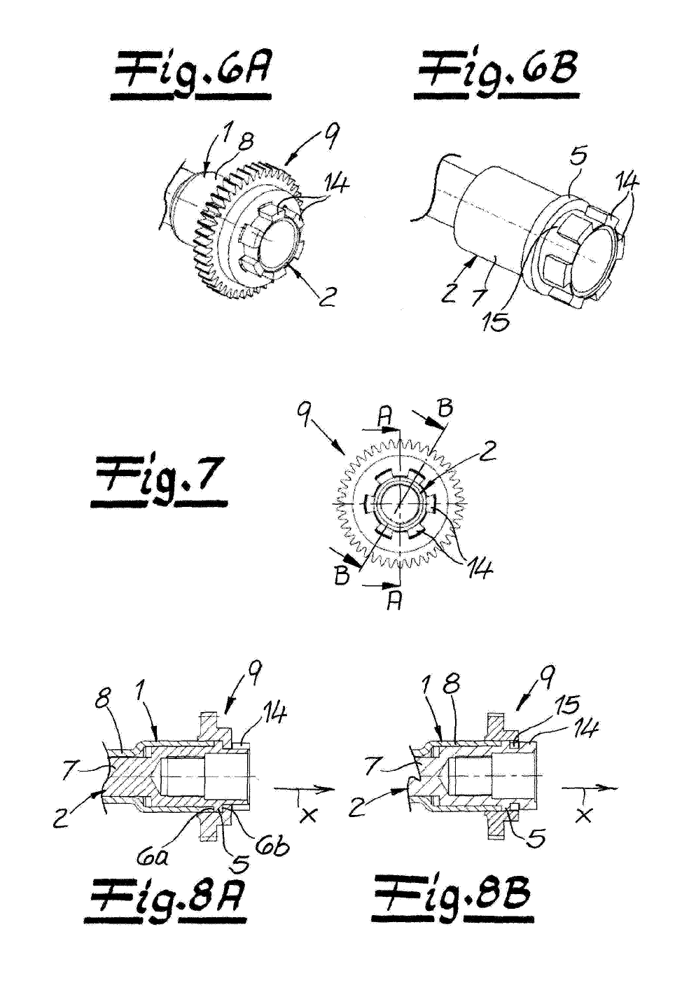

FIG. 7 is an end view of the camshaft shown in FIG. 6A,

FIG. 8A is a section along line A-A of FIG. 7,

FIG. 8B is a section along line B-B of FIG. 7,

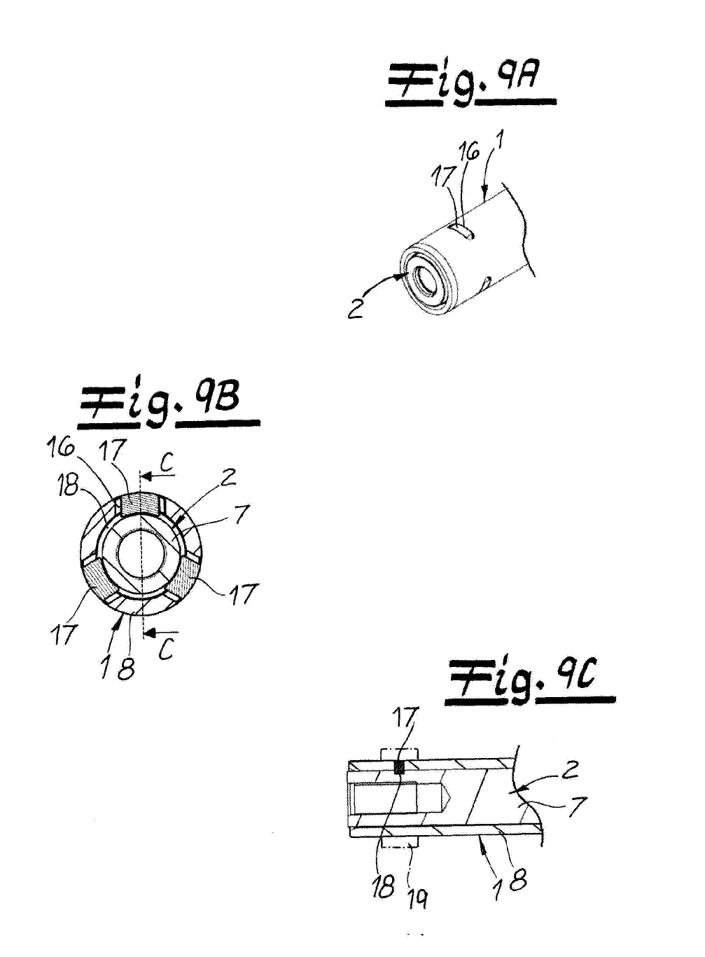

FIG. 9A is a perspective view of an alternative embodiment of the camshaft,

FIG. 9B is a cross section through the camshaft according to FIG. 9A,

FIG. 9C is a longitudinal section along the line C-C of FIG. 9B,

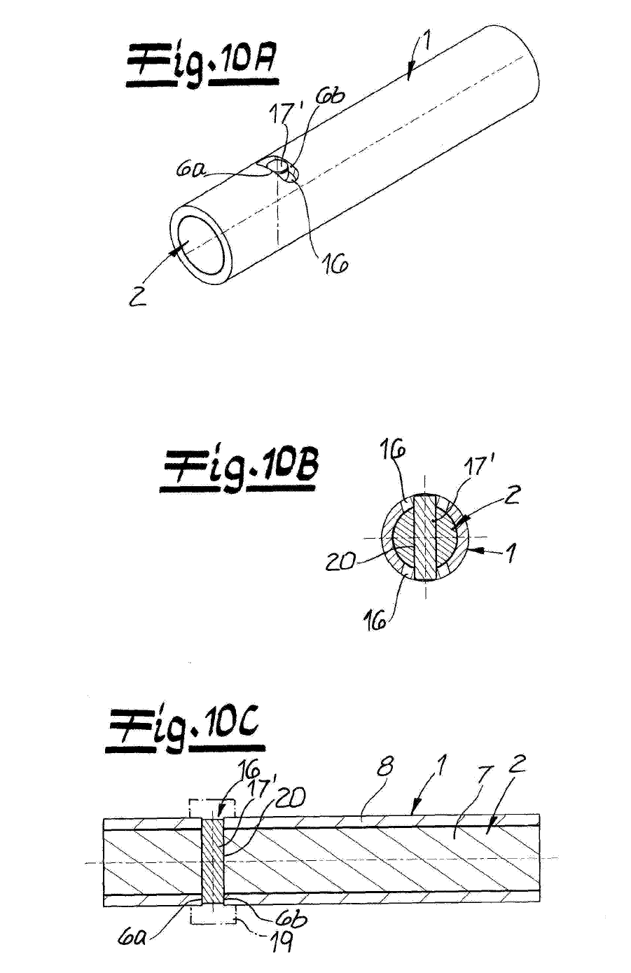

FIGS. 10A to 10C show an alternative embodiment of the camshaft in a view like FIGS. 9A to 9C,

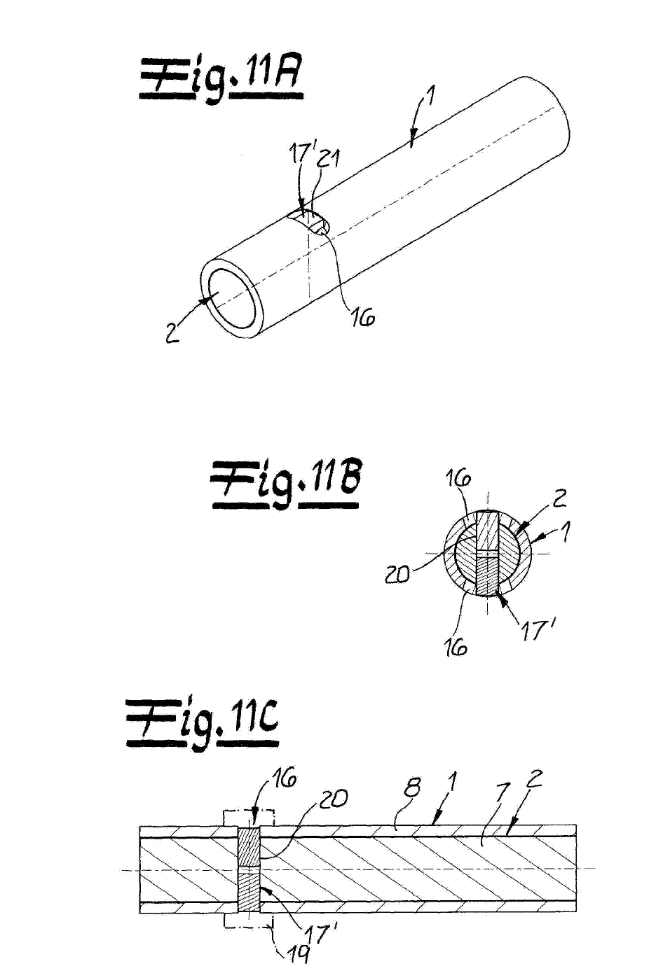

FIGS. 11A to 11C show an alternative embodiment of the camshaft in a view like FIGS. 9A to 9C,

FIG. 12 is a longitudinal section through an alternative embodiment of the camshaft,

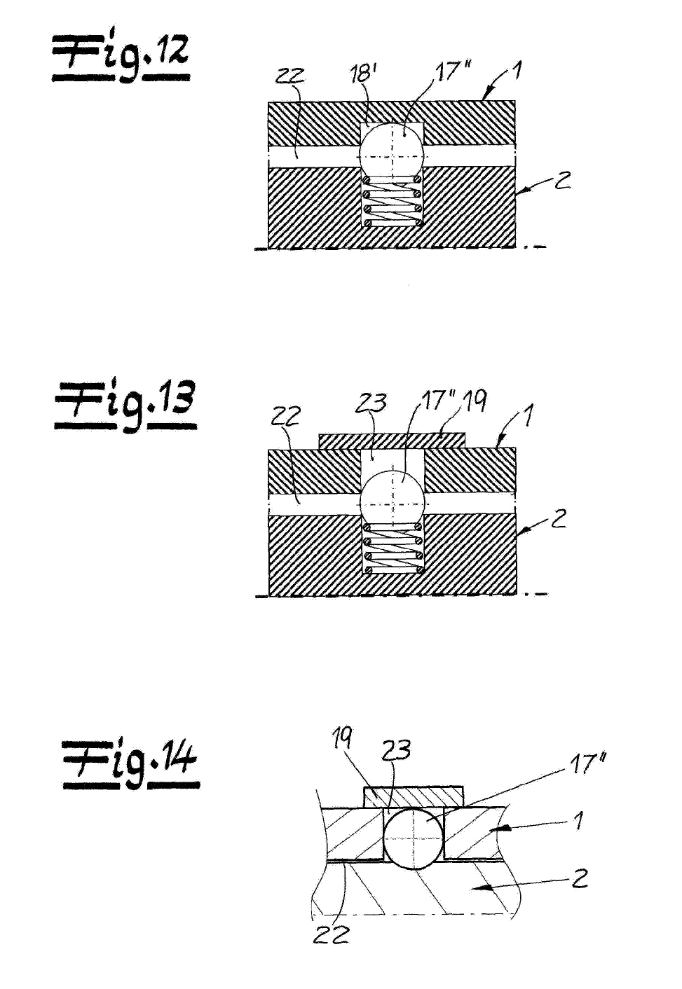

FIG. 13 is a longitudinal section through an alternative embodiment of the camshaft, and

FIG. 14 is a longitudinal section through an alternative embodiment of the camshaft.

The invention relates to an adjustable camshaft that according to its principal design comprises a first shaft and a second shaft that form a hollow outer shaft 1 and an inner shaft 2 that extends coaxially in the hollow outer shaft 1 and can rotate relative to the outer shaft. FIG. 1A shows that first cams 3a are fixed on the outer shaft 1 and second cams 3b can move angularly relative to the outer shaft 1 and are fixed rotationally to the inner shaft 2 with suitable fixing means 4, in particular with pins. FIG. 1A shows one end of such a camshaft.

The present invention deals with the axial support of the outer shaft 1 and the inner shaft 2 rotatable therein. In this regard, it is to generally accepted no axial play should be present between the inner shaft 2 and the outer shaft 1, but at the same time a sliding without jamming should be achieved.

To this end, according to the present invention an interlocking fixing and support in an axial direction x are provided. In general, the first shaft and the second shaft are braced against each other in the axial direction x by an interlocking formation 5, and the first shaft has, axially, a first contact surface 6a on one axial face of the interlocking formation 5 and a second contact surface 6b on the other axial face of the interlocking formation 5 for rotationally supporting the second shaft by means of the interlocking formation 5.

Starting from this basic principle according to the invention, the embodiment according to FIGS. 1A and 1B is a camshaft where the interlocking formation 5 is formed as a radially outwardly projecting ridge on the inner shaft 2. The interlocking formation 5 is here directly formed on a one-piece inner shaft base body 7 of the inner shaft 2. A functional element 9 in the form of a gear for driving the camshaft is fixed on a tubular base body 8 of the outer shaft 1. The functional element 9 can be fixed with the usual measures, for example by means of welding, friction welding, soldering, adhesive bonding, shrinking, screwing, or generating a transverse/longitudinal composite unit. Depending on the type of fixing, various materials are suitable, provided they are able to withstand the operational materials present on the camshaft as well as the temperatures encountered in an internal combustion engine, the generation of an interlocking connection or a combination of the above-mentioned measures.

According to FIG. 1A, the interlocking formation formed as an annular radial projection bears on one side on the end face of the tubular base body 8 of the outer shaft 1 forming the first contact surface 6a. The opposite contact surface 6b is formed by a surface of the functional element 9. During manufacturing, the inner shaft 2 is first inserted into the base body 8 of the outer shaft 1 and then the functional element 9 is fixed to the base body 8 of the outer shaft 1. During this, a force may be exerted on the functional element axially 9 that on the one hand allows the play between the interlocking formation 5 and the contact surfaces 6a, 6b to be minimized and on the other hand allows for easy adjustability of the inner shaft 2 relative to the outer shaft 1.

FIG. 2 shows a modification to the embodiment shown in FIG. 1A, wherein the inner diameter of the functional element 9 at the interlocking formation 5 is adapted to the outer diameter of the interlocking formation 5 in such a way that additionally also a radial contact surface 10 for forming a radial bearing is provided. Also conceivable is a radial support of the inner shaft 2 on the inner diameter of the outer shaft 1. Here, the projection of the functional element 9 forming the surface 6b would act on the inner shaft (cf. FIG. 1A).

FIGS. 3A and 3B show an alternative embodiment where the interlocking formation 5 is not provided on the base body 8 of the inner shaft 2 but on an additional inner shaft end piece 11 of the inner shaft 2 that is axially directly fixed to the inner shaft base body 7. According to the variants shown in FIGS. 3A and 3B, the inner shaft end piece 11 may be fixed either to the outer surface of the inner shaft base body 7 (FIG. 3A) or to an end face of the inner shaft base body (FIG. 3B). The inner shaft base body 7 may be a solid rod or a tube. In the case of a tube the advantage is achieved that also further means that, for example, an oil supply for the phaser can be integrated into the camshaft. Moreover, a weight reduction is achieved.

In FIGS. 3A and 3B, contrary to the embodiment according to FIG. 1A, the first contact surface 6a is formed by the functional element 9, whereas a separate end ring 12 is inserted into the functional element 9 and is fixed to the functional element 9 to form the second contact surface 6b. For reasons of clarity, FIG. 3B does not show the corresponding parts of the outer shaft 1.

FIGS. 4 and 5 show a further embodiment where, instead of a functional element 9, a simple sleeve 13 is provided that forms the second contact surface 6b. As shown in FIGS. 1A and 2, the interlocking formation 5 may be provided merely as an axial support (FIG. 4) or in addition also as a radial support (FIG. 5), if the outer diameter on the interlocking formation 5 is dimensioned to the inner diameter of the sleeve 13 in the corresponding region. Radial support is also possible between the projection of the sleeve 13 forming the second contact surface 6b and the inner shaft 2.

In the specific embodiments described above, during the manufacturing process, first of all the inner shaft 2 is inserted into the base body 8 of the outer shaft 1, before the functional element 9 (FIG. 1A and FIG. 2), the end ring 12 (FIG. 3A) or the sleeve 13 (FIG. 4 and FIG. 5) are attached and connected to the base body 8 of the outer shaft 1. The embodiment according to FIGS. 6A, 6B, 7, 8A and 8B is based on the same approach where, for increasing the outer diameter of the inner shaft 2, teeth are provided. The teeth 14 provided on the inner shaft 2 are, during the mounting process, extending through apertures of the functional element 9, these apertures merely having an oversize as required for the mounting process. However, in order to allow, once the functional element 9 has been fixedly connected to the base body 8 of the outer shaft, rotation of the inner shaft 2 relative to the outer shaft 1, according to FIG. 6B, which merely shows the inner shaft 2, an annular groove 15 is provided between the teeth 14 and the interlocking formation 5. Radial support of the interlocking formation is provided, according to FIG. 8A, in a manner similar to the embodiment according to FIG. 1A on the end face of the base body 8 of the outer shaft 1 as a first contact surface as well as on a second contact surface 6b formed by the functional element 9. A comparison of FIGS. 6A and 6B shows that the second contact surface 6b is interrupted at the apertures.

It can in particular be seen especially from FIGS. 8A and 8B that the tubular base body 8 of the outer shaft 1 has a region of enlarged diameter. Apart from the widening of the base body 8, also a multi-piece embodiment is considered for achieving a wide-diameter region.

While in the embodiment so far described the interlocking formation 5 is to be provided at a shaft end of the camshaft, the explanations following below relate to embodiments wherein the support location for the axial support may be in any desired position along the camshaft. However, for practical reasons, the axial support will preferably be at least in the vicinity of one end of the camshaft here as well.

According to FIG. 9A, the outer shaft 1 has openings formed as slots 16. In these slots 16, separate interlocking elements 17 are provided as the interlocking formation 5. A comparison of FIGS. 9B and 9C shows that the inner shaft 2 has a circumferential groove 18 in which the three interlocking elements 17 engage that are arranged around the circumference at a uniform angular spacing. As a result of the interlocking elements 17, precise axial support becomes possible, with the inner shaft 2 remaining rotatable relative to the outer shaft 1. In order to secure the interlocking elements 17 against contamination and/or falling out, a ring 19 may be provided that covers the interlocking elements 17 on the outer shaft 1. This optional ring 19 is indicated in FIG. 9C.

FIGS. 10A to 10C show an embodiment wherein the inner shaft 2 has a hole 20 in the support location and into which an interlocking element 17′ in the form of a pin has been fitted. At the opening 20, the outer shaft 1 has slots 16 in order to allow movement of the interlocking element 17′ in the case of an adjustment of the inner shaft 2 relative to the outer shaft 1. In the case of a simple cylindrical pin as the interlocking element 17′, there is line contact between this interlocking element 17′ and the two contact surfaces 6a, 6b along the edges of the slots 16.

In order to reduce wear in connection with this, according to FIGS. 11A to 11C an interlocking element 17′ in the form of a pin having lateral planar flats on a head 21 may be provided.

In the embodiments of FIGS. 10A to 10C as well as FIGS. 11A to 11C, too, a ring 19 may be provided for protection and for avoiding any excess oil loss.

Finally, FIG. 12 shows an embodiment wherein a separate interlocking element 17″ in the form of a ball is provided, the outer shaft 1 merely having an internal circumferential groove 18′. As a result, the ball as an interlocking element 17″ is optimally protected against external influences at an annular gap 22 between the inner shaft 2 and the outer shaft 1, and no oil can escape at the support either. However, the machining of the internal circumferential groove 18′ in the outer shaft 1 is associated with increased complexity.

In the light of this, FIG. 13 shows an alternative embodiment where an elongated hole 16 instead of the circumferential groove 18′ is provided in the outer shaft. The elongated hole 16 allows rotation of the inner shaft 2 relative to the outer shaft 1. In order to prevent any oil from leaking out here, a ring 19 is provided as a cover.

Finally, FIG. 14 shows a development of the embodiment described above, where at least one, preferably several balls are provided as an interlocking element 17″ or as interlocking elements 17″. The balls are mounted in bores 23 of the outer shaft 1. The inner shaft preferably has a circumferential groove for receiving the ball.

In this embodiment, the ring 19 is used as a counter bearing for the balls and can moreover prevent oil leaks.

1. A camshaft for a motor-vehicle engine, the crankshaft comprising:
a first shaft and a second shaft that form a tubular outer shaft extending along an axis;
an inner shaft extending coaxially in the outer shaft and rotatable about the axis relative to the outer shaft,
first cams rotationally fixed on the outer shaft;
second cams rotatable on the outer shaft and fixed to the inner shaft;
an interlocking formation braced axially between the first shaft and the second shaft;
a first contact on the first shaft to one axial side of the interlocking formation; and
a second contact surface on the other axial side of the interlocking formation rotationally supporting the second shaft through the interlocking formation.

2. The camshaft as claimed in claim 1, wherein the interlocking formation is part of the second shaft.

3. The camshaft as claimed in claim 1 wherein the inner shaft extends beyond a tubular base body of the outer shaft at one camshaft end and has there the interlocking formation that projects radially outward beyond an inner diameter of the tubular base body.

4. The camshaft as claimed in claim 3, wherein the interlocking formation bears in one axial direction on an end face of the base body and bears in an opposite other axial direction on a part of the outer shaft that is axially fixed to the base body.

5. The camshaft as claimed in claim 3, wherein the interlocking formation is the contact surfaces that are formed by at least one part that is axially fixed to the base body.

6. The camshaft as claimed in claim 4, wherein the part of the outer shaft is a functional element of the camshaft.

7. The camshaft as claimed in claim 4, wherein the part of the outer shaft is fixed to the base body by an interlocking or adhesive or frictional connection.

8. The camshaft as claimed in claim 1, wherein the inner shaft has an inner shaft base body as well as an inner shaft end piece, the interlocking formation being formed on the inner shaft end piece.

9. The camshaft as claimed in claim 8, wherein the interlocking formation is supported on the first shaft also radially.

10. The camshaft as claimed in claim 1, wherein the inner shaft and the outer shaft have, at a support location starting from an annular gap between the inner shaft and the outer shaft, a recess in the form of an indent, a circumferential groove or an opening, at least one separate interlocking element that engages in this recess being provided as the interlocking formation.

11. The camshaft as claimed in claim 10, wherein in the support location, the outer shaft has at least one opening and the inner shaft has a circumferential groove, at least one interlocking element being inserted into the opening and engaging in the circumferential groove.

12. The camshaft as claimed in claim 11, wherein the at least one opening of the outer shaft is an angularly elongated hole.

13. The camshaft as claimed in claim 11, wherein a ball is the interlocking element.

14. The camshaft as claimed in claim 10, wherein the outer shaft has, starting from the annular gap, a recess in the form of a circumferential groove, the interlocking element being provided on the inner shaft in a radially movable manner and carrying an elastic pressure element.

15. The camshaft as claimed in claim 10, wherein the inner shaft has an opening in the support location, and that the outer shaft has, on either side of the opening respective angularly elongated holes, a pin fitted into the opening being provided as the interlocking element.

16. The camshaft as claimed in claim 15, wherein the pin has lateral planar surfaces on at least one end.
